(19) United States
(12) Patent Application Publication
(10) Pub. No.: US 2015/0240892 A1
(43) Pub. Date: Aug. 27, 2015

(54) DISC BRAKE DEVICE OF AN INVERSION TABLE

(71) Applicant: CLOUD FITNESS CO., LTD., Taichung City (TW)

(72) Inventor: Tsao-Kuang Wei, Taichung City (TW)

(73) Assignee: CLOUD FITNESS CO., LTD., Taichung City (TW)

(21) Appl. No.: 14/188,920

(22) Filed: Feb. 25, 2014

(51) Int. Cl. F16D 65/14; F16D 65/12; F16D 55/225

(52) U.S. Cl. CPC F16D 65/14; F16D 55/225; F16D 65/128

(57) ABSTRACT

An inversion table with a disc brake device has base a bottom stand, two bases, a disc brake module, a frame module, a controlling unit, and a lying plate combined with the two bases. The disc brake module has a disc brake body combined with the bases.

### BACKGROUND OF THE INVENTION

1. Field of the Invention

The present invention relates to a disc brake device, and more particularly to a disc brake device of an inversion table.

2. Description of Related Art

A conventional inversion table has a bottom base, two pivoting units, a lying plate and a brake unit. The bottom base has two supporting points. The pivoting units are respectively mounted on the supporting points. The lying plate is elongated and two sides of the lying plate are respectively mounted on the pivoting units, such that the lying plate can be pivoted relative to the bottom base at the pivoting units. The brake unit is mounted on one of the pivoting units and is applied for controlling the motion of the lying plate relative to the bottom base.

In use, a user lies on the lying plate to engage in a flip sport. The brake unit is operated by the user for controlling the lying plate. When the brake unit is released, the lying plate can be pivoted relative to the bottom base. On the other hand, when the brake unit is locked, the position of the lying plate relative to the bottom base is fixed. Therefore, the user can control the brake unit to hold the lying plate in position, and then the user can be engaged in flipping to exercise the muscles.

However, the brake unit of the inversion table cannot provide a stepless braking effect, such that the braking performance of the conventional inversion table needs to be improved.

### SUMMARY OF THE INVENTION

The main objective of the present invention is to provide a disc brake device of an inversion table that has an improved braking performance.

The disc brake device of an inversion table has a base, a disc brake module, a frame module, and a controlling unit.

The disc brake module is mounted on the base and has a disc brake body combined with the base.

The frame module is mounted on the base and has an insertion portion, a supporting plate and a controlling unit base. The insertion portion is inserted through the disc brake body and is inserted into the base. The supporting plate is connected with the insertion portion. The controlling unit base is connected with the supporting plate.

The controlling unit is mounted on the controlling unit base and has a handle, a connecting stick, a spring, a connecting stick base and a caliper base. The handle abuts the controlling unit base. The connecting stick is inserted through the controlling unit base and is combined with the handle. The spring is mounted around the connecting stick and abuts between the connecting stick and the controlling unit base. The connecting stick base is mounted around and is engaged with the connecting stick at a position opposite to the controlling unit base. The caliper base is combined with the connecting stick base and is mounted around the disc brake body.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of a disc brake device in accordance with the present invention mounted on an inversion table;

FIG. 2 is an exploded perspective view of the disc brake device in FIG. 1;

FIG. 3 is an enlarged perspective view of the disc brake device in FIG. 1;

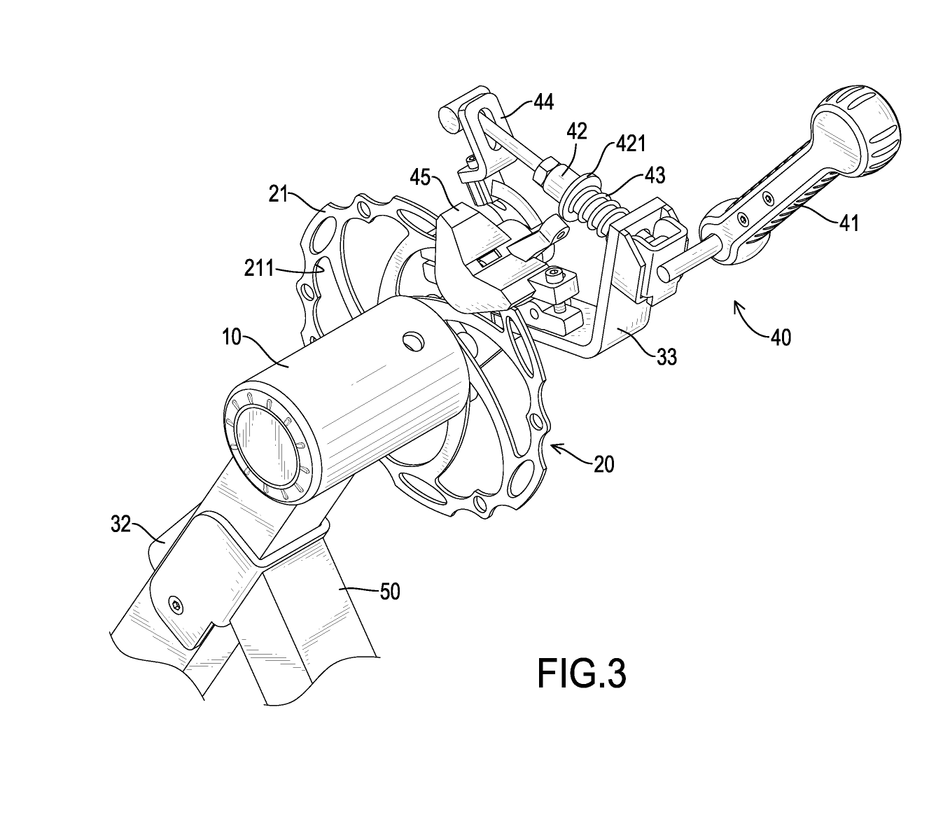

FIG. 4 is another enlarged perspective view of the disc brake device in FIG. 1; and

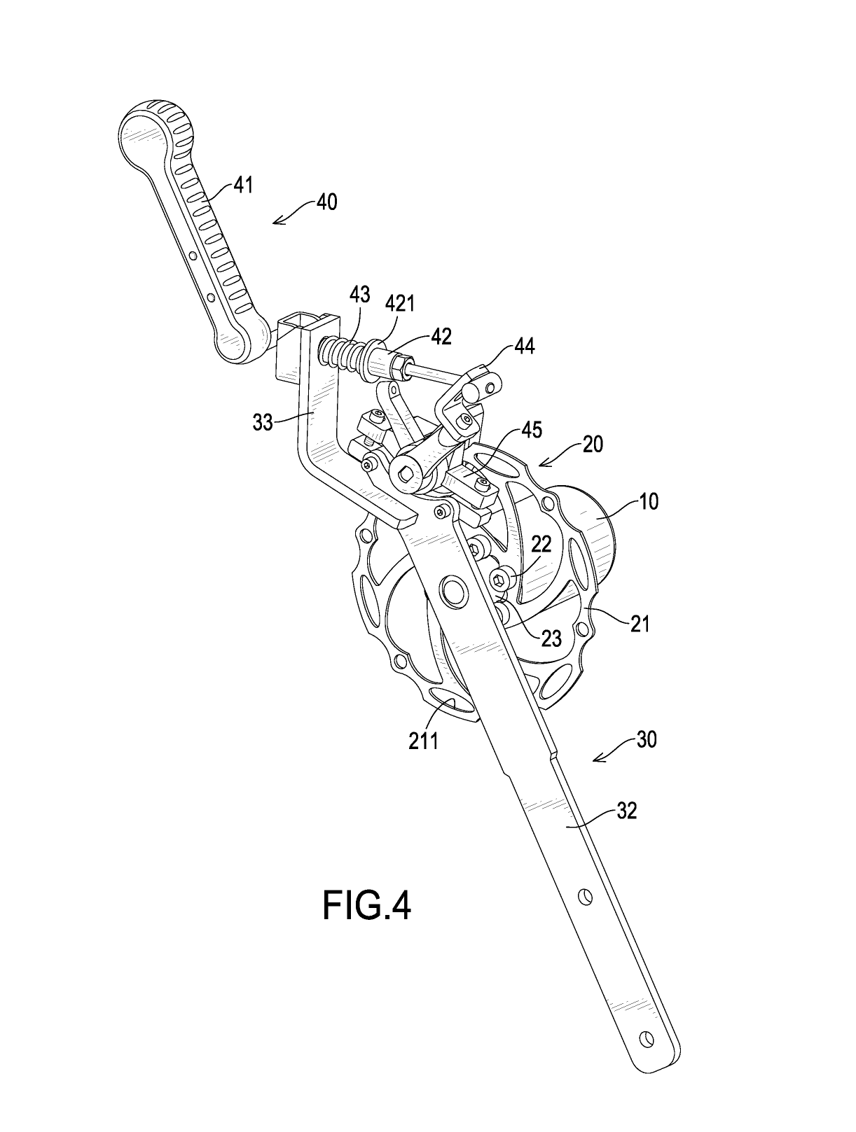

FIG. 5 is an enlarged side view of the disc brake device in FIG. 1.

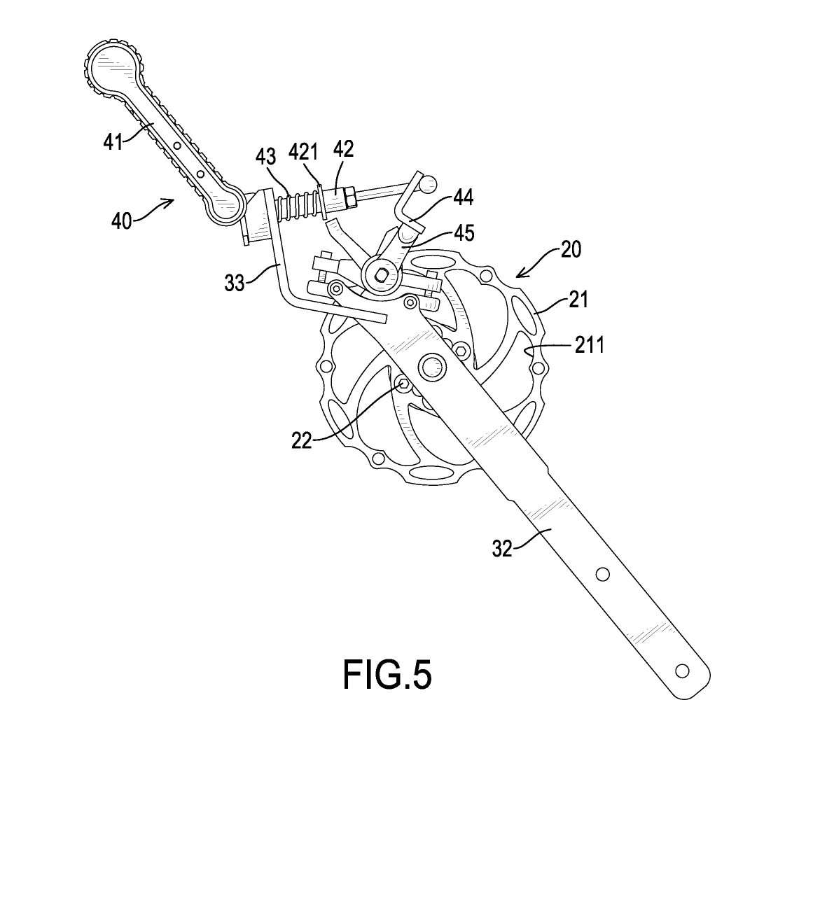

### DETAILED DESCRIPTION OF PREFERRED EMBODIMENT

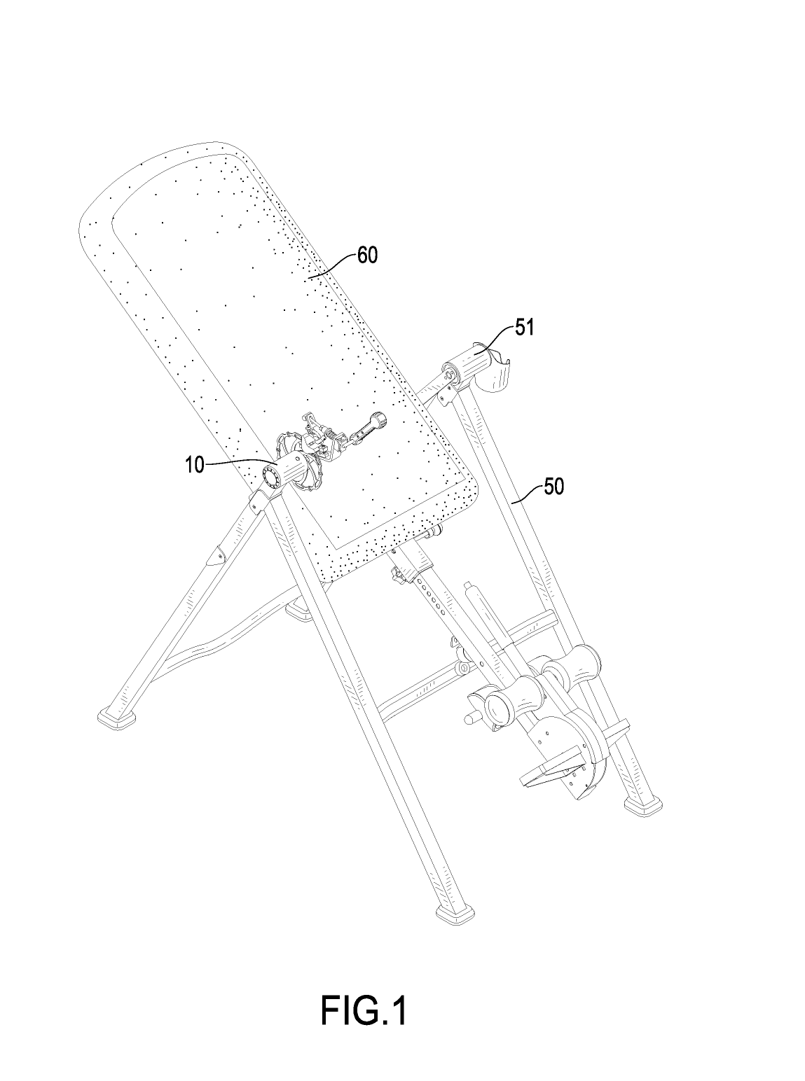

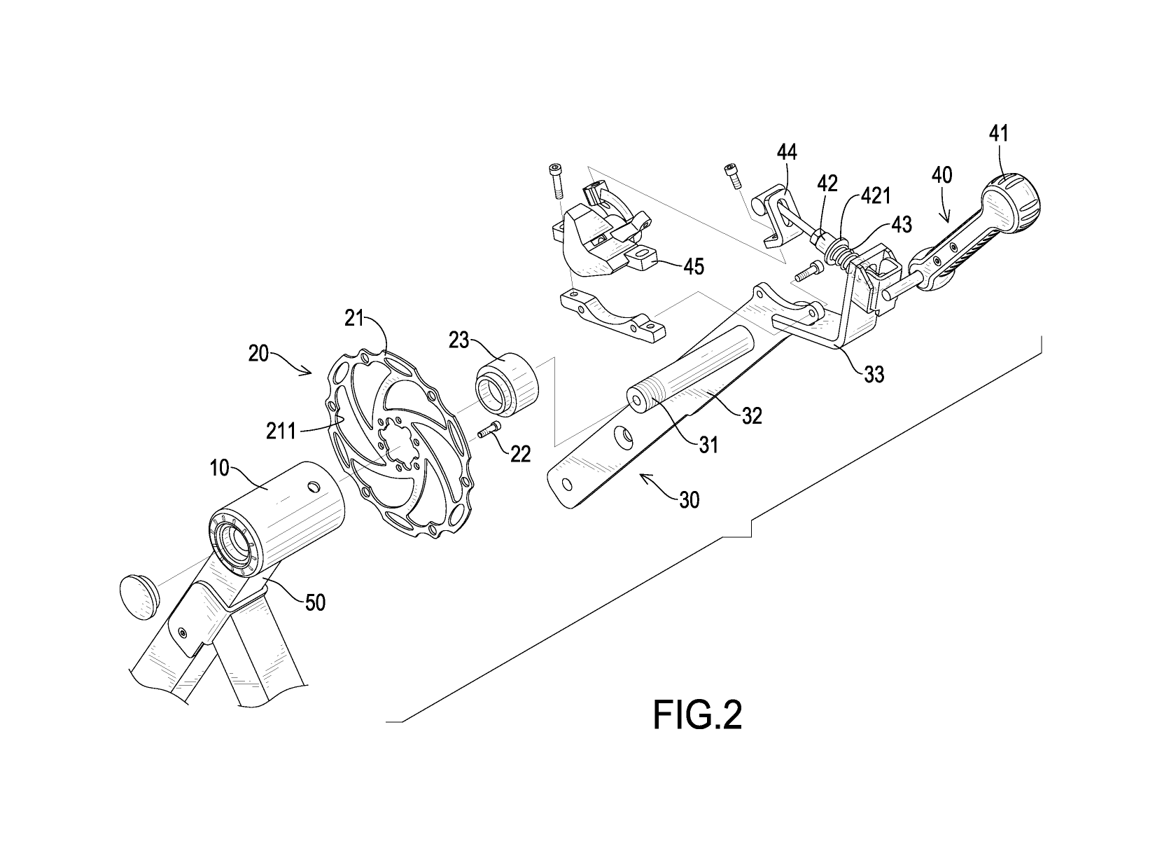

With reference to FIGS. 1 and 2, a first preferred embodiment of a disc brake device of an inversion table in accordance with the present invention has a base 10, a disc brake module 20, a frame module 30, and a controlling unit 40.

The base 10 is mounted on a bottom stand 50 of an inversion table, wherein the bottom stand 50 has two tops, and the base 10 is mounted on one of the tops of the bottom stand 50. The disc brake device is mounted on the bottom stand 50 by the base 10.

The disc brake module 20 is mounted on the base 10 and has a disc brake body 21, multiple fixing bolts 22 and a hub 23. The disc brake body 21 abuts the base 10, is fixed on the base 10 by the fixing bolts 22, and has multiple heat dissipating holes 211. The heat dissipating holes 211 are formed through the disc brake body 21 to increase a surface area of the disc brake body 21 to improve a heat-dissipating effect. The hub 23 is hollow, and is inserted into a middle of the base 10 and a middle of the disc brake body 21.

The frame module 30 is mounted on the base 10 and has an insertion portion 31, a supporting plate 32 and a controlling unit base 33. The insertion portion 31 is inserted into a middle of the hub 23 and the base 10. The insertion portion 31 can be rotated relative to the base 10. The supporting plate 32 is connected with an end of the insertion portion 31 at a position opposite to the base 10. The supporting plate 32 abuts the hub 23 and is perpendicular to the insertion portion 31. The supporting plate 32 is applied to be combined with a lying plate. The controlling unit base 33 is connected with an end of the supporting plate 32.

The controlling unit 40 is mounted on the controlling unit base 33 and has a handle 41, a connecting stick 42, a spring 43, a connecting stick base 44 and a caliper base 45. The handle 41 abuts the controlling unit base 33. The connecting stick 42 has two ends and a rib 421, wherein one of the ends of the connecting stick 42 is inserted through the controlling unit base 33 and is combined with the handle 41. The spring 43 is mounted around the connecting stick 42 and abuts between the rib 421 of the connecting stick 42 and the controlling unit base 33. The connecting stick base 44 is mounted around one of the ends of the connecting stick 42 at a position opposite to the controlling unit base 33. The caliper base 45 is combined with the connecting stick base 44, is mounted around a part of the outer edge of the disc brake body 21, and selectively clamps the disc brake body 21.

In use, the frame module 30 and the controlling unit 40 can be selectively and simultaneously rotated relative to the disc brake module 20. Another base 51 is mounted on the other one of the tops of the bottom stand 50 of the inversion table opposite to the disc brake device. A lying plate 60 is combined with the two bases 51, 10. A user lies on the lying plate 60 to be engaged in a flipping sport.

The user can pull the handle 41 to sequentially pull the connecting stick 42 and the connecting stick base 44. The caliper base 45 is driven by the connecting stick base 44 to clamp the disc brake body 21, wherein the caliper base 45 abuts the disc brake body 21 to generate a friction between the caliper base 45 and the disc brake body 21. The friction can decelerate the frame module 30 and the controlling unit 40 relative to the disc brake body 21. When the frame module 30 is stopped rotating relative to the disc brake body 21 by the friction, the lying plate 60 is also stopped rotating and is positioned, such that a position of the lying plate 60 relative to the bottom stand 50 can be fixed.

Therefore, the user can lie on the lying plate 60 and control the position of the lying plate 60 relative to the bottom stand 50 to exercise muscles, such that the disc brake device can help the user achieve an exercising and fitness effect.

From the above description, it is noted that the present invention has the following advantages:

A cooperation of the disc brake module 20 and the controlling unit 40 can control the caliper base 45 to selectively clamp the disc brake body 21. When the caliper base 45 clamps the disc brake body 21, the friction between the caliper base 45 and the disc brake body 21 can decelerate the frame module 30 and the controlling unit 40 relative to the base 10, so as to fix the position of the lying plate 60 relative to the bottom stand 50. Furthermore, the clamping relationship between the caliper base 45 and the disc brake body 21 can achieve a stepless braking effect, such that the braking performance of the disc brake device is improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An inversion table with a disc brake device having:
a bottom stand having two tops;
two bases respectively mounted on the tops of the bottom stand;
a disc brake module mounted on one of the bases and having a disc brake body combined with said one of the bases;
a frame module mounted on the base that is combined with the disc brake body and having
an insertion portion inserted through the disc brake body and inserted into the base that is combined with the disc brake body;
a supporting plate connected with the insertion portion; and
a controlling unit base connected with the supporting plate; and a controlling unit mounted on the controlling unit base and having
a handle abutting the controlling unit base;
a connecting stick inserted through the controlling unit base and combined with the handle;
a spring mounted around the connecting stick and abutting between the connecting stick and the controlling unit base;
a connecting stick base mounted around and engaged with the connecting stick at a position opposite to the controlling unit base; and
a caliper base combined with the connecting stick base and mounted around a part of an outer edge of the disc brake body; and
a lying plate combined with the two bases.

2. The inversion table with a disc brake device as claimed in claim 1, wherein the disc brake body further has multiple heat dissipating holes formed through the disc brake body.

3. The inversion table with a disc brake device as claimed in claim 1, wherein the disc brake module further has a hub mounted between the disc brake body and the supporting plate, mounted around the insertion portion, and inserted into the base that is combined with the disc brake body.

4. The inversion table with a disc brake device as claimed in claim 2, wherein the disc brake module further has a hub mounted between the disc brake body and the supporting plate, mounted around the insertion portion, and inserted into the base that is combined with the disc brake body.
